(19) United States
(12) Patent Application Publication
(10) Pub. No.: US 2018/0301293 A1
(43) Pub. Date: Oct. 18, 2018

(54) ONBOARD LOAD CONTROL DEVICE AND COMPUTER PROGRAM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka (JP)

(72) Inventors: Takeo Uchino, Yokkaichi (JP); Takeshi Uraki, Yokkaichi (JP); Junpei Horii, Yokkaichi (JP); Yuuki Sugisawa, Yokkaichi (JP); Kazunori Yamaguchi, Yokkaichi (JP); Tatsuya Daidoji, Yokkaichi (JP)

(21) Appl. No.: 15/566,393

(22) PCT Filed: Apr. 5, 2016
(86) PCT No.: PCT/JP2016/061093

§ 371 Date: Oct. 13, 2017

(30) Foreign Application Priority Data
Apr. 20, 2015 (JP) 2015-085705

(51) Int. Cl. H01H 9/50; H01H 47/00; H01H 47/02

(52) U.S. Cl. CPC H01H 9/50; B60R 16/03; H01H 47/02; H01H 47/002

(57) ABSTRACT

Provided is an onboard load control device and a computer program that can reliably detect and extinguish an arc discharge occurring between a pair of terminals of a connector. Arc discharges are caused in advance between terminals of a connector 2 that relays connection to onboard loads, a wireless detection unit receives electromagnetic waves generated due to the arc discharges, and detects frequency distributions of received intensities, and the detected frequency distributions are stored in a ROM in association with the respective onboard loads. Thereafter, frequency distributions that are acquired by the wireless detection unit chronologically are compared with the frequency distributions stored in the ROM, and the electric current flowing to the onboard load that corresponds to the matching frequency distributions is interrupted.

### CROSS-REFERENCE TO RELATED APPLICATIONS

This application is the U.S. national stage of PCT/JP2016/061093 filed Apr. 5, 2016, which claims priority of Japanese Patent Application No. JP 2015-085705 filed Apr. 20, 2015.

### TECHNICAL FIELD

The present invention relates to an onboard load control device and a computer program that turns an electric current on/off that flows via a pair of terminals of a connector to an onboard load.

### BACKGROUND

It is known that, when contacts are opened and closed, an arc discharge occurs if a difference in potential between the contacts is higher than a so-called minimum arc voltage and if a contact current is higher than a minimum arc current. Particularly, if contacts through which a DC current is flowing are opened and closed, then the discharge will continue for a longer time than in a case where an AC current is flowing therethrough.

If an arc discharge occurs between contacts, there is the risk that, due to high heat caused by the arc discharge, the contacts may be damaged, for example, oxidized, blackened, or welded, or electromagnetic wave noise may be generated that affects peripheral electronic circuits, for example. Accordingly, once an arc discharge occurs, it is preferably extinguished as soon as possible.

JP 2010-199521A, for example, discloses a LED lighting device in which a load voltage applied to a load having a plurality of LEDs (or a load current flowing through the load) from a constant-current power supply (or a constant-voltage power supply) is sampled with a predetermined cycle, and if a sampling result indicates that the load voltage is increased by a predetermined voltage or more (or the load current is decreased by a predetermined current or more), then it is determined that an arc discharge has occurred, and the constant-current power supply (or the constant-voltage power supply) is disabled. In this context, “predetermined voltage” refers to a voltage that is lower than an increase in an output voltage from the constant-current power supply according to a minimum arc voltage, and “minimum current” is an electric current that is lower than a decrease in the load current when the voltage applied across the load is reduced according to the minimum arc voltage.

However, in the technique disclosed in JP 2010-199521A, there is the risk that, if a load is changed, an arc discharge cannot be detected or is detected erroneously.

The present invention was made in view of such circumstances, and it is an object thereof to provide an onboard load control device and a computer program that can reliably detect and extinguish an arc discharge occurring at a pair of terminals of a connector.

### SUMMARY

According to one aspect of the present invention, an onboard load control device that turns an electric current on/off that flows via a pair or pairs of terminals of a connector to one or more onboard loads includes: a wireless detection unit configured to receive an electromagnetic wave and to detect a frequency distribution of received intensities; a storage unit configured to store in advance, in association with each onboard load, a frequency distribution that is detected by the wireless detection unit when an arc discharge is caused between the pair of terminals through which the electric current flows to the onboard load; an acquiring unit configured to chronologically acquire a frequency distribution detected by the wireless detection unit; a comparison unit configured to compare the frequency distribution acquired by the acquiring unit with the frequency distribution stored in the storage unit; and a current interrupting unit configured to interrupt, if a result of the comparison by the comparison unit shows that the frequency distributions match, the electric current that flows to the onboard load that corresponds to the matching frequency distributions.

According to one aspect of the present invention, the comparison unit may be configured to perform the comparison of received intensities with respect to each of a plurality of different frequencies or frequency bands.

According to one aspect of the present invention, the comparison unit may be configured to compare logarithms of the received intensities.

According to one aspect of the present invention, the comparison unit may be configured to perform the comparison based on a first threshold.

According to one aspect of the present invention, the storage unit may be configured to store in advance frequency distributions that are detected by the wireless detection unit when an arc discharge is caused with respect to a plurality of electric currents flowing through the pair or pairs of terminals, further in association with the respective electric currents, a current detecting unit configured to chronologically detect an electric current flowing to the onboard load may be provided, and the comparison unit may be configured to compare the frequency distribution acquired by the acquiring unit with that frequency distribution out of the frequency distributions stored in the storage unit in association with the onboard load that corresponds to the electric current that is closest to the electric current detected by the current detecting unit.

According to one aspect of the present invention, the onboard load control device may further include: a calculation unit configured to calculate a decrease ratio or decrease amount of the electric current detected by the current detecting unit; and a determination unit configured to determine whether or not the decrease ratio or decrease amount calculated by the calculation unit is greater than a second threshold, wherein the comparison unit is configured to perform the comparison if it is determined by the determination unit that the decrease ratio or decrease amount is greater than the second threshold.

According to one aspect of the present invention, the onboard load control device may further include: a wiring board on which the connector and the wireless detection unit are mounted, wherein the wiring board is provided with an antenna with which the wireless detection unit receives the electromagnetic wave.

According to one aspect of the present invention, a computer program causes a computer to extinguish an arc discharge occurring in a connector based on a detection result of a wireless detection unit, the computer being connected to: the wireless detection unit configured to receive an electromagnetic wave and to detect a frequency distribution of received intensities; and a storage unit configured to store in advance a frequency distribution that is detected by the wireless detection unit when an arc discharge is caused between a pair of terminals of the connector through which an electric current flows to each of one or more onboard loads in association with the onboard load, and being configured to turn the electric current on/off that flows to the onboard load, wherein the computer program causes the computer to function as: an acquiring unit configured to chronologically acquire a frequency distribution detected by the wireless detection unit; a comparison unit configured to compare the frequency distribution acquired by the acquiring unit with the frequency distribution stored in the storage unit; and a current interrupting unit configured to perform control to interrupt, if a result of the comparison by the comparison unit shows that the frequency distributions match, the electric current that flows to the onboard load that corresponds to the matching frequency distributions.

According to the above-described aspect, for each of one or more onboard loads, an arc discharge is caused in advance between a pair of terminals of a connector that relays connection to the onboard load, the wireless detection unit receives an electromagnetic wave generated due to the arc discharge, and detects a frequency distribution of received intensities, and the detected frequency distribution is stored in the storage unit in association with the onboard load. Thereafter, a frequency distribution acquired by the wireless detection unit chronologically is compared with the frequency distribution stored in the storage unit, and an electric current flowing to the onboard load that corresponds to the matching frequency distributions is interrupted.

Accordingly, if there is a match between a frequency distribution that is acquired when an arc discharge has actually occurred between a pair or pairs of terminals, and a frequency distribution stored in advance, then the onboard load that corresponds to the matching frequency distributions is identified, the electric current flowing to the identified onboard load is interrupted, and the arc is extinguished.

According to the above-described aspect, since the comparison of received intensities is performed with respect to each of a plurality of different frequencies or frequency bands, whether the frequency distributions of received intensities are identical is efficiently compared.

According to the above-described aspect, since the comparison is performed using logarithms of the received intensities with respect to each of a plurality of different frequencies or frequency bands, subtracting the logarithm values suffices as the calculation for the comparison.

According to the above-described aspect, when logarithms of received intensities are compared based on the first threshold, a difference between the received intensities with respect to each frequency or frequency band is compared with the first threshold, or a sum of differences between the logarithms of the received intensities of frequencies or frequency bands is compared with the first threshold, for example.

According to the above-described aspect, the storage unit stores, in association with each of one or more onboard loads, frequency distributions of received intensities that are detected by the wireless detection unit when an arc discharge is caused each time an electric current flowing between a pair or pairs of terminals is varied in advance into a plurality of patterns, and a plurality of frequency distributions for each onboard load are stored in association with the electric currents detected when the arc discharges are caused. Thereafter, an electric current flowing to each of one or more onboard loads is detected chronologically, and a frequency distribution acquired chronologically from the wireless detection unit is compared with that frequency distribution out of the plurality of frequency distributions stored in the storage unit in association with the onboard load that corresponds to the electric current that is closest to the electric current detected chronologically.

Accordingly, even if the electric current flowing to the onboard load is not constant when an arc discharge occurs, a frequency distribution to be compared is extracted from among the frequency distributions stored in the storage unit based on the electric current flowing to the onboard load when an arc discharge actually occurs.

According to the above-described aspect, if a decrease ratio or decrease amount of the electric current detected for each of one or more onboard loads is greater than the second threshold, then the frequency distribution acquired from the wireless detection unit is compared with that frequency distribution out of the plurality of frequency distributions stored in the storage unit in association with the onboard load that corresponds to the electric current that is closest to the detected electric current.

Accordingly, since the comparison is performed when an arc discharge has occurred between a pair of terminals and an electric resistance of the pair of terminals has started to increase, the time and target of comparison are narrowed down, reducing the processing load of the comparison.

According to the above-described aspect, the antenna is formed on the wiring board on which the connector and the wireless detection unit are mounted, and the positional relationship between the antenna, and a pair of terminals between which an arc discharge is generated is fixed on the wiring board, and thus an accurate comparison is performed between a frequency distribution stored in advance and a frequency distribution detected by the wireless detection unit.

### Advantageous Effects of Invention

As described above, if a frequency distribution acquired when an arc discharge has actually occurred between a pair of terminals is similar to, that is, matching a stored frequency distribution, then the onboard load that is stored in association with the matching frequency distributions is identified, the electric current flowing to the identified onboard load is interrupted, and the arc is extinguished.

Accordingly, it is possible to reliably detect and extinguish an arc discharge occurring between a pair of terminals of a connector.

### BRIEF DESCRIPTION OF DRAWINGS

FIG. 1 is a block diagram illustrating an example of a configuration of an onboard load control device according to Embodiment 1.

FIG. 2 is a graph illustrating the intensities of electromagnetic waves that are generated due to an arc discharge.

FIG. 3 is a table illustrating examples of content stored in advance in a ROM of the onboard load control device according to Embodiment 1.

FIG. 4 is a flowchart illustrating a processing procedure of the onboard load control device of Embodiment 1 in which a CPU controls an electric current flowing to onboard loads to be interrupted.

FIG. 5 is a block diagram illustrating an example of a configuration of an onboard load control device according to Embodiment 2.

FIG. 6 is a table illustrating examples of content stored in advance in a ROM of the onboard load control device according to Embodiment 2.

FIG. 7 is a flowchart illustrating a processing procedure of the onboard load control device of Embodiment 2 in which a CPU controls an electric current flowing to onboard loads to be interrupted.

FIG. 8 is a flowchart illustrating a processing procedure of an arc extinguishing subroutine that is performed by the CPU, according to Embodiment 2.

FIG. 9 is a flowchart illustrating a processing procedure of an arc extinguishing subroutine that is performed by the CPU, according to Embodiment 3.

### DETAILED DESCRIPTION OF PREFERRED EMBODIMENTS

Hereinafter, the present invention will be described in detail with reference to the drawings illustrating embodiments thereof.

### Embodiment 1

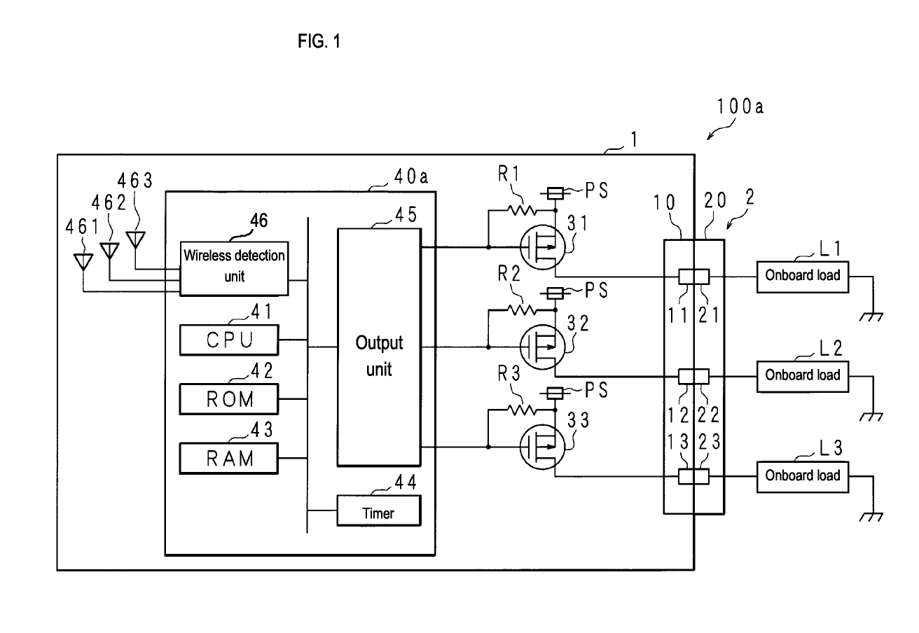

FIG. 1 is a block diagram illustrating an example of a configuration of an onboard load control device according to Embodiment 1. In the drawing, the reference numeral 100a denotes an onboard load control device installed in a vehicle, and the onboard load control device 100a is provided with: P-channel type MOSFETs (Metal Oxide Semiconductor Field Effect Transistor: hereinafter, abbreviated simply as “FETs”) 31, 32, and 33 that respectively turns electric currents on/off that flow through a connector 2 to onboard loads L1, L2, and L3; and a control unit 40a that turns the FETs on/off. The onboard loads L1, L2, and L3 are high current loads such as a head lamp, a room lamp, a power steering, or a defogger, for example.

The FETs 31, 32, and 33 and the control unit 40a are arranged on a wiring board 1, but the present invention is not limited to this. The FETs may be of an N-channel type, or may be other switches such as IGBTs (Insulated Gate Bipolar Transistors) or semiconductor relays. The number of FETs, that is, the number of onboard loads is not limited to three, and may also be one, two, or n (where “n” is a natural number not smaller than 4).

The connector 2 is configured such that a plug 20 on a wire harness side is fitted to a receptacle 10 arranged on the wiring board 1. A configuration is also possible in which a receptacle on the wire harness side is fitted to a plug arranged on the wiring board 1. Furthermore, the receptacle 10 of the connector 2 is not necessarily arranged on the wiring board 1, and the entire connector 2 may be arranged on the outside of the onboard load control device 100a.

The receptacle 10 includes terminals 11, 12, and 13 that are respectively connected to drains of the FETs 31, 32, and 33. The terminals 11, 12, and 13 may also be accommodated in two or more different receptacles. The plug 20 includes terminals 21, 22, and 23 that are respectively connected to the onboard loads L1, L2, and L3. The terminals 21, 22, and 23 may also be accommodated in two or more different plugs. The terminals 11 and 21, and the terminals 12 and 22, and the terminals 13 and 33 correspond to pairs of terminals, and are electrically connected to each other as a result of the plug 20 on the wire harness side being fitted into the receptacle 10.

Resistors R1, R2, and R3 are respectively connected between the drains and gates of the FETs 31, 32, and 33, and the drains of the resistors R1, R2, and R3 are connected to a power supply PS. The drains of the FETs 31, 32, and 33 may also be connected to different power supplies.

The control unit 40a includes a CPU (Central Processing Unit) 41 that plays a central role in various types of control of the onboard load control device 100a , and the CPU 41 is connected, via a bus, to a ROM (Read Only Memory: corresponding to a storage unit) 42 in which a control program and information such as frequency distributions that have been acquired in advance are stored, a RAM (Random Access Memory) 43 in which temporarily generated information is stored, and a timer 44 that keeps various types of time.

Furthermore, an output unit 45 for outputting control signals to the gates of the FETs 31, 32, and 33, and a wireless detection unit 46 that receives electromagnetic waves using antennas 461, 462, and 463 to detect frequency distributions of received intensities are connected to the CPU 41 via a bus.

The antennas 461, 462, and 463 are respectively formed in the vicinity of the terminals 11, 12, and 13 on the wiring board 1, but the present invention is not limited to this. The antennas 461, 462, and 463 may also be formed at positions apart from the wiring board 1, and may be fixed relative to the wiring board 1. The number of the antennas is not limited to three, and may also be one, two, four, or more. Particularly, when the terminals 11, 12, and 13 are accommodated in different connectors, different antennas may be arranged for the respective terminals.

The antennas 461, 462, and 463 are, for example, magnetic field type loop antennas, and are configured to acquire broadband electromagnetic waves having wavelengths that are sufficiently longer than the wavelengths that correspond to their sizes, and to generate voltages that are substantially proportional to the magnetic field. The type of the antennas is not limited to this, and any type of antennas may be acceptable.

The wireless detection unit 46 includes wireless modules (not shown) that respectively correspond to a plurality of different frequencies (or frequency bands), and the wireless modules respectively detect, as received intensities, relative received powers specific to the frequencies (or frequency bands). The frequency distribution detected by the wireless detection unit 46 is expressed by a set of received intensities detected by a wireless module. In other words, “frequency distribution” in this context refers to the received intensities in the plurality of different frequencies (or frequency bands). If received intensities of the same frequency (or frequency band) are different, then the frequency distributions are regarded as different frequency distributions even when the received intensities have the same distribution characteristic (that is, frequency characteristic).

In the above-described configuration, for example, if the plug 20 and the receptacle 10 are disengaged while currents are flowing to the onboard loads L1, L2, and L3, or if the vehicle travels while the plug 20 and the receptacle 10 are imperfectly fitted to each other, there may be cases where arc discharges occur between the terminals 11 and 21, between the terminals 12 and 22, and between the terminals 13 and 23. If an arc discharge occurs in the vicinity of an electronic circuit, there may be the risk that the electronic circuit malfunctions under the influence of an electromagnetic wave generated due to the arc discharge. The terminals between which an arc discharge has occurred may also be damaged, and thus it is preferable to immediately extinguish the arc discharge that has occurred.

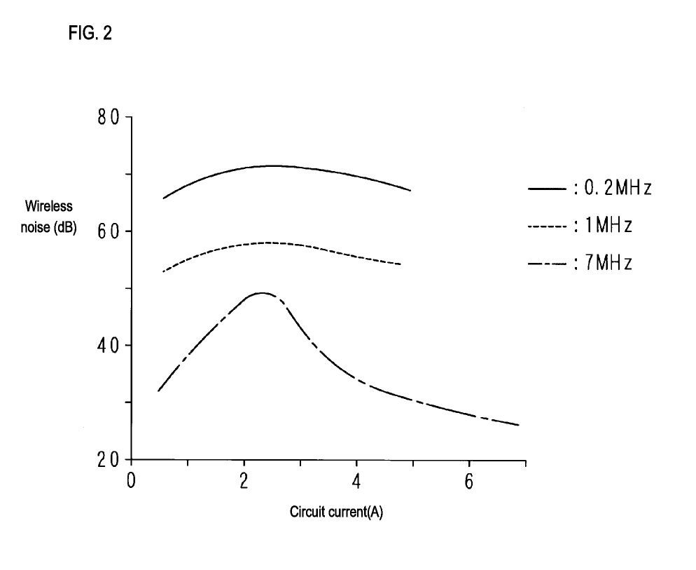

FIG. 2 is a graph showing intensities of electromagnetic waves generated by an arc discharge (cited from Tasuku, TAKAGI “Arc Discharge Phenomenon of Electric Contacts”, Corona Publishing, February 1995, on pp132-133). In FIG. 2, the horizontal axis denotes a circuit current (A) that is flowing through electric contacts when the arc discharge occurs, and the vertical axis denotes the relative intensities (dB) of electromagnetic waves, that is, wireless noise. Curves with a solid line, a dotted line, and a dashed-dotted line of FIG. 2 respectively denote the general relationship between the circuit current and the wireless noise for the frequencies of 0.2 MHz, 1 MHz, and 7 MHz.

The graph of FIG. 2 shows a general tendency in which the intensities of the wireless noise generated due to an arc discharge are substantially inversely proportional to the frequency, and have the so-called 1/f noise characteristics. Furthermore, the wireless noise intensity of each frequency increases up to 2 to 3 A, and the wireless noise intensity particularly on the high frequency side depends to a greater extent on the circuit current. Accordingly, it is clear that frequency distributions of wireless noise generated due to arc discharges occurring between the terminals 11 and 21, between the terminals 12 and 22, and between the terminals 13 and 23 respectively depend on the electric currents flowing to the onboard loads L1, L2, and L3.

On the other hand, the directivity of the antennas 461, 462, and 463 that acquire wireless noise generated by arc discharges is not uniform in all directions, and the positional relationships between the antennas 461, 462, and 463, and the terminals 11 and 21, the terminals 12 and 22, and the terminals 13 and 23 are different from each other. Accordingly, even if the electric currents flowing to the onboard loads L1, L2, and L3 are constant, frequency distributions of the received intensities of the wireless noise due to arc discharges that are detected by the wireless detection unit 46 are different among the onboard loads L1, L2, and L3. In reality, it is conceivable that the above-described frequency distributions of the received intensities vary to a greater extent due to a difference in configuration among the terminals 11 and 21, the terminals 12 and 22, and the terminals 13 and 23, or a difference in the electric current flowing therethrough.

Accordingly, arc discharges are caused in advance between the terminals 11 and 21, between the terminals 12 and 22, and between the terminals 13 and 23, and the frequency distributions of received intensities are detected by the wireless detection unit 46 and are stored in the ROM 42 in association with the onboard loads L1, L2, and L3. Thereafter, by comparing them with frequency distributions of received intensities detected by the wireless detection unit 46, it is possible to identify the onboard load to which an electric current is flowing via the pair of terminals between which the arc discharge has occurred. Then, by interrupting the electric current flowing to the identified onboard load using the corresponding FET, it is possible to extinguish the arc discharge.

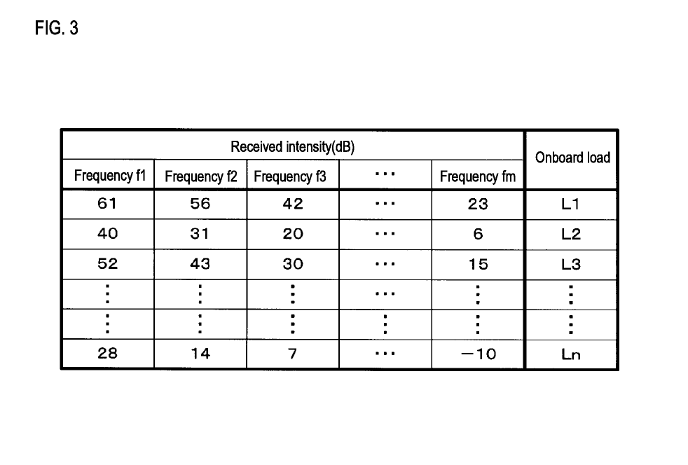

FIG. 3 is a table showing examples of content that is stored in advance in the ROM 42 of the onboard load control device 100a according to Embodiment 1. Here, logarithms of received intensities of frequencies f1, f2, f3, . . . fm (where m is a natural number not smaller than 4) are stored for each of the onboard loads L1, L2, L3, . . . Ln (where n is a natural number not smaller than 4: L4 onwards are not shown), but logarithms of received intensities in frequency bands with the frequencies f1, f2, f3, . . . fm located in the center may also be stored, or received intensities before taking their logarithms may also be stored. When the received intensities that are acquired in advance change over time, it is sufficient to define a suitable acquisition timing. Furthermore, if the number of onboard loads is not greater than 3, then it is sufficient to delete an unnecessary row in the table shown in FIG. 3 depending on the number of onboard loads.

Specifically in FIG. 3, the received intensities 61, 56, 42, . . . 23 (dB) in the frequencies f1, f2, f3, . . . fm are stored in association with the onboard load L1. Similarly, the received intensities 40, 31, 20, . . . 6 (dB) are stored in association with the onboard load L2, and the received intensities 52, 43, 30, . . . 15 (dB) are stored in association with the onboard load L3. Furthermore, the received intensities 28, 14, 7, . . . −10 (dB) are stored in association with the onboard load Ln.

The following will describe an operation of the above-described control unit 40a with reference to the flowchart indicating the operation. The processing shown below is executed by the CPU 41 in accordance with a control program stored in advance in the ROM 42.

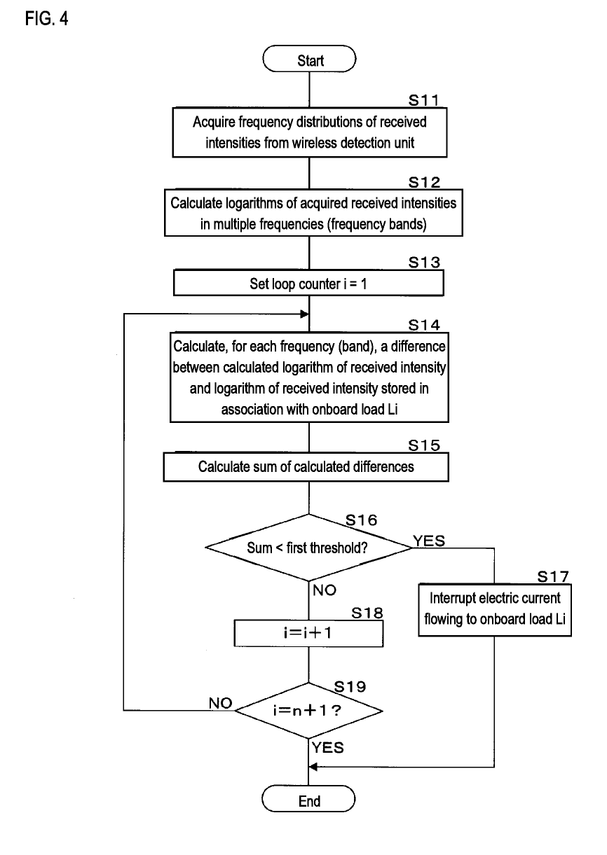

FIG. 4 is a flowchart showing the processing procedure of the onboard load control device 100a according to Embodiment 1 in which the CPU 41 controls an electric current flowing to any of the onboard loads L1, L2, . . . Ln to be interrupted. The procedure shown in FIG. 4 is started periodically, for example, every 10 ms, but the period of start is not limited to 10 ms, and may also be nonperiodic. The electric currents that flow to the onboard loads L1, L2, . . . Ln have already been controlled to flow.

When the processing of FIG. 4 is started, the CPU 41 acquires, from the wireless detection unit 46, frequency distributions of received intensities, that is, received intensities in a plurality of frequencies (or frequency bands) (step S11: corresponding to an acquiring unit), and calculates the logarithms of the acquired received intensities (step S12). If the logarithms of the received intensities are acquired from the wireless detection unit 46, then it is sufficient to omit step S12.

Then, the CPU 41 initializes a loop counter i to 1 (step S13), and calculates, for each frequency (or each frequency band) from the frequency f1 to the frequency fm, a difference between the logarithm of the received intensity calculated in step S12 and the logarithm of received intensity stored in the ROM 42 in association with an onboard load Li (step S14), and calculates the sum of the calculated differences (step S15).

Then, the CPU 41 determines whether or not the calculated sum is smaller than a first threshold (step S16), and if it is smaller than the first threshold (Yes in step S16), then the CPU 41 uses the output unit 45 to turn off an FETi (the FET4 onwards are not shown), and interrupts an electric current flowing to the onboard load Li (step S17: corresponding to a current interrupting unit). Thus, the procedure of FIG. 4 ends. The above-described steps S14 to S16 correspond to a comparison unit.

Note that in steps S15 and S16, the sum of differences is compared with the first threshold, but it is also possible to determine whether or not each difference is smaller than the first threshold (for example, a value of about 1 to 2 dB).

If the calculated sum is not smaller than the first threshold (No in step S16), then the CPU 41 increments the loop counter i by 1 (step S18), and determines whether or not the loop counter i is n+1, that is, whether or not the comparison between the received intensities acquired from the wireless detection unit 46 and the received intensities stored in the ROM 42 is complete with respect to all the onboard loads (step S19). If the loop counter i is n+1 (Yes in step S19), then the CPU 41 ends the procedure of FIG. 4, and if the loop counter i is not n+1 (No in step S19), then the CPU 41 advances the procedure to step S14 to continue the comparison.

As described above, according to Embodiment 1, arc discharges are caused in advance between the terminals 11 and 21, between the terminals 12 and 22, and between the terminals 13 and 23 of the connector 2 that relays connection to the onboard loads L1, L2, and L3, the wireless detection unit 46 receives electromagnetic waves generated due to the arc discharges, and detects frequency distributions of received intensities, and the detected frequency distributions are stored in the ROM 42 in association with the onboard loads L1, L2, and L3. Thereafter, the frequency distributions acquired every 10 ms by the wireless detection unit 46 are compared with the frequency distributions stored in the ROM 42, and the electric current flowing to the onboard load that corresponds to the matching frequency distribution is interrupted.

Accordingly, if there is a match between a frequency distribution that is acquired when an arc discharge has actually occurred between the terminals 11 and 21, between the terminals 12 and 22, or between the terminals 13 and 23, and a frequency distribution that is stored in advance in the ROM 42, then the onboard load that corresponds to the matching frequency distributions is identified, the electric current flowing to the identified onboard load is interrupted, and the arc is extinguished.

Therefore, it is possible to reliably detect and extinguish an arc discharge.

Furthermore, according to Embodiment 1, since the comparison of the received intensities is performed for each frequency or frequency band from the frequency f1 to the frequency fm, it is possible to efficiently compare whether the frequency distributions of received intensities are identical.

Furthermore, according to Embodiment 1, since the comparison of frequency distributions is performed using logarithms of received intensities with respect to each frequency or frequency band from the frequency f1 to the frequency fm, subtracting the logarithm values suffices as the calculation for the comparison.

Furthermore, according to Embodiment 1, when logarithms of received intensities are compared based on the first threshold, it is possible to determine whether or not a difference between the received intensities with respect to each frequency or frequency band is smaller than the first threshold, or whether or not a sum of differences between logarithms of the received intensities of frequencies or frequency bands is smaller than the first threshold.

Moreover, according to Embodiment 1, the antennas 461, 462, and 463 are formed on the wiring board 1 on which the receptacle 10 of the connector 2 and the wireless detection unit 46 are mounted, and the positional relationship between the antennas 461, 462, and 463, and the terminals 11 and 21, the terminals 12 and 22, and the terminals 13 and 33 between which arc discharges are generated is fixed on the wiring board 1, and thus it is possible to perform an accurate comparison between frequency distributions stored in advance in the ROM 42 with frequency distributions detected by the wireless detection unit 46.

### Embodiment 2

In contrast to Embodiment 1 in which the comparison of frequency distributions is performed without detecting electric currents flowing to the onboard loads L1, L2, . . . Ln, Embodiment 2 is an embodiment in which electric currents flowing to the onboard loads L1, L2, . . . Ln are detected, and frequency distributions to be compared are selected based on the detected electric currents.

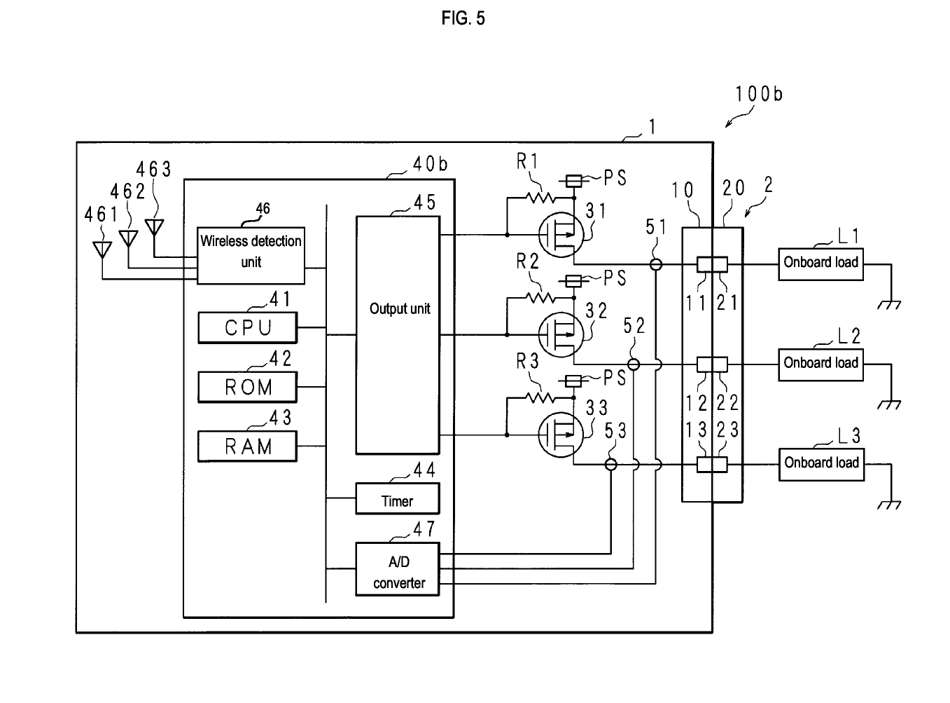

FIG. 5 is a block diagram illustrating an example of a configuration of an onboard load control device according to Embodiment 2. In the drawing, the reference numeral 100b denotes an onboard load control device installed in a vehicle, and the onboard load control device 100b is provided with: the FETs 31, 32, and 33 that respectively turn electric currents on/off that flow through the connector 2 to the onboard loads L1, L2, and L3; current sensors 51, 52, and 53 that respectively detect the electric currents flowing to the onboard loads L1, L2, and L3 to output analog detection voltages; and a control unit 40b that turns the FETs on/off.

In contrast to the control unit 40a of Embodiment 1, the control unit 40b further includes an A/D converter 47 that converts the analog detection voltages from the current sensors 51, 52, and 53 into digital values, and the A/D converter 47 is connected to a CPU 41 via a bus. With this configuration, the CPU 41 detects the electric currents flowing to the onboard loads L1, L2, and L3 in digital values.

The same reference numerals are given to other components that correspond to those of Embodiment 1, and their further description is omitted.

In Embodiment 2, arc discharges are caused each time electric currents flowing between the terminals 11 and 21, between the terminals 12 and 22, . . . and between the terminals 1n and 2n (the terminals 14 and 24 onwards are not shown) are varied in advance into a plurality of patterns, and the frequency distributions of received intensities are detected by the wireless detection unit 46. Then, the detected frequency distributions of the received intensities are stored in a ROM 42 in association with the electric currents detected when the arc discharges are caused.

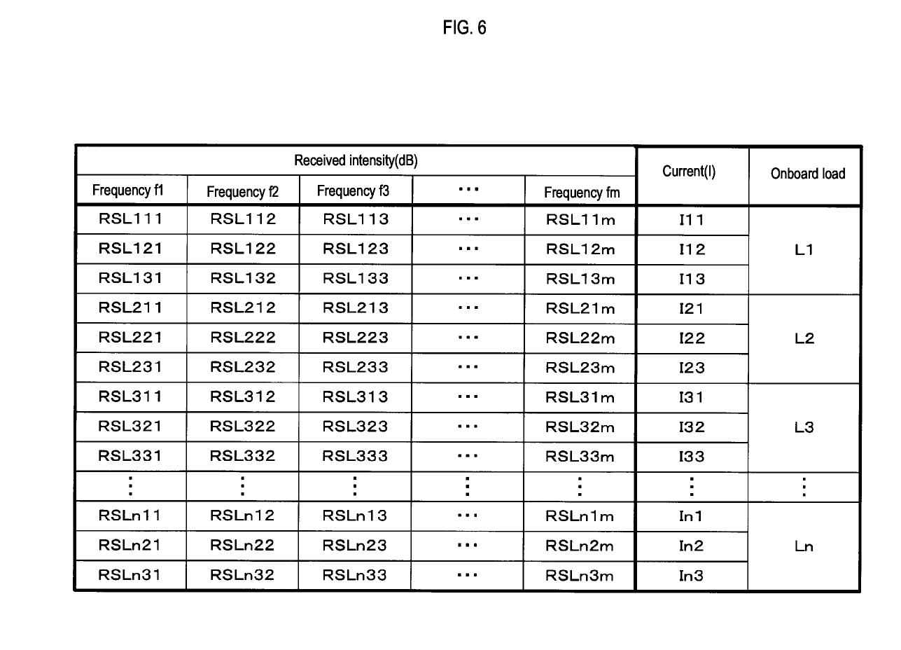

FIG. 6 is a table showing examples of the content that is stored in advance in the ROM 42 of the onboard load control device 100b according to Embodiment 2. Here, for each of the onboard loads L1, L2, L3, . . . Ln, logarithms of received intensities at the frequencies f1, f2, f3, . . . fm are stored in association with three types of electric currents. Each received intensity has a logarithm value indicated by RSL (Received Signal Level) ijk (where: i is a natural number not greater than n; j is 1, 2, or 3; and k is a natural number not greater than m). Specifically, for the onboard load Li, received intensities RSLijk (dB) at the frequencies f1, f2, f3, . . . fm are stored in association with the electric current Iij.

When frequency distributions of received intensities detected by the wireless detection unit 46 are later compared with frequency distributions of received intensities stored in the ROM 42, electric currents flowing to the onboard loads L1, L2, L3, . . . Ln are detected. Then, the frequency distributions detected by the wireless detection unit 46 are compared with the frequency distributions out of a plurality of frequency distributions stored in association with the onboard loads L1, L2, L3, . . . Ln that correspond to the electric current that is closest to the detected electric current. If there is a match between the frequency distributions, then the onboard load is identified to which the electric current is flowing via the pair of terminals between which the arc discharge has occurred.

The following will describe an operation of the above-described control unit 40b with reference to the flowchart indicating the operation.

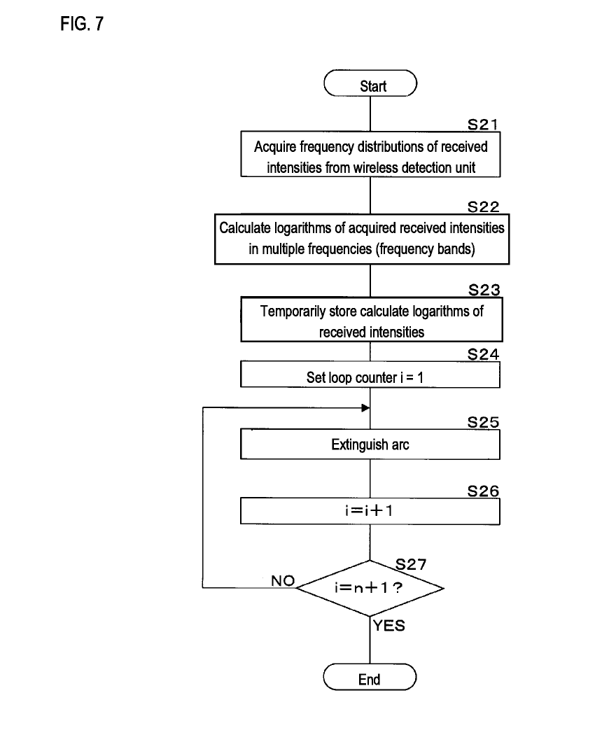

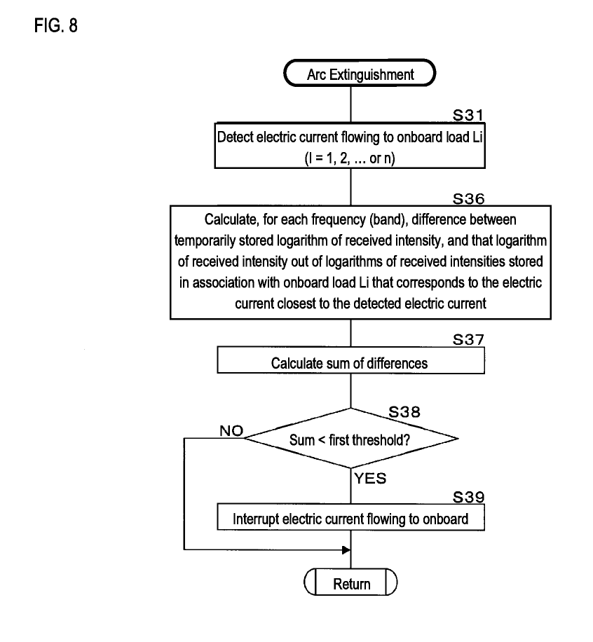

FIG. 7 is a flowchart showing the processing procedure of the onboard load control device 100b according to Embodiment 2 in which the CPU 41 performs control such that an electric current flowing to any of the onboard loads L1, L2, . . . Ln is interrupted, and FIG. 8 is a flowchart showing the processing procedure of an arc extinguishing subroutine that is performed by the CPU 41, according to Embodiment 2. The processing of FIG. 7 is started periodically, for example, every 10 ms, but the present invention is not limited to this. The electric currents that follow to the onboard loads L1, L2, . . . Ln have already been controlled to flow.

When the processing of the main routine shown in FIG. 7 is started, the CPU 41 acquires, from the wireless detection unit 46, frequency distributions of received intensities, that is, received intensities in a plurality of frequencies (or frequency bands) (step S21: corresponding to an acquiring unit), calculates logarithms of the acquired received intensities (step S22), and temporarily stores the calculated logarithms of the received intensities in a RAM 43 (step S23). Then, the CPU 41 initializes the loop counter i to 1 (step S24), invokes the arc extinguishing subroutine, and executes the invoked subroutine (step S25).

Then, the CPU 41 increments the loop counter i by 1 (step S26), and determines whether or not the loop counter i is n+1, that is, whether or not the comparison between the received intensities acquired from the wireless detection unit 46 and the received intensities stored in the ROM 42 is complete with respect to all the onboard loads (step S27). If the loop counter i is n+1 (Yes in step S27), then the CPU 41 ends the procedure of FIG. 7, and if the loop counter i is not n+1 (No in step S27), then the CPU 41 advances the procedure to step S25 to continue the comparison.

Then, when the arc extinguishing subroutine shown in FIG. 8 is invoked, the CPU 41 detects an electric current that is flowing to the onboard load Li (where i is a loop counter i when the subroutine is invoked, and corresponds to 1, 2, . . . or n) (step S31: corresponding to a current detecting unit). Then, the CPU 41 calculates, for each frequency (or each frequency band) from the frequency f1 to the frequency fm, a difference between the temporarily stored logarithm of the received intensity, and that logarithm of the received intensity out of the logarithms of the received intensities stored in the ROM 42 in association with the onboard load Li that corresponds to the electric current closest to the electric current detected in step S31 (step S36).

For example, if 2.2 A is detected as the electric current flowing to the onboard load L1, and I11=1 A, I12=2 A, and I13=3 A are stored in the ROM 42, then differences, for the respective frequencies f1, f2, f3, . . . fm, between the temporarily stored logarithms of the received intensities, and the received intensities RSL121, RSL122, RSL123, . . . RAL12m that correspond to I12, which is closest to the detected electric current, are calculated.

Then, the CPU 41 calculates the sum of the calculated differences (step S37), and determines whether or not the calculated sum is smaller than the first threshold (step S38). If the sum is not smaller than the first threshold (No in step S38), then the CPU 41 returns to the routine from which the subroutine is invoked. On the other hand, if the sum is smaller than the first threshold (Yes in step S38), then the CPU 41 turns off the FETi using the output unit 45 to interrupt the electric current flowing to the onboard load Li (step S39: corresponding to a current interrupting unit), and returns to the routine from which the subroutine is invoked.

As described above, according to Embodiment 2, the frequency distributions that are stored in the ROM 42 in association with the onboard loads L1, L2, . . . Ln are distributions of received intensities that are detected by the wireless detection unit 46 when arc discharges are caused each time electric currents flowing between the terminals 11 and 21, between the terminals 12 and 22, . . . between the terminals 1n and 2n are varied in advance into a plurality of patterns, and a plurality of frequency distributions for each of the onboard loads L1, L2, . . . Ln are stored in association with the electric currents detected when the arc discharges are caused. Thereafter, an electric current flowing to each of the onboard loads L1, L2, . . . Ln is detected chronologically, and frequency distributions acquired chronologically from the wireless detection unit 46 are compared with the frequency distributions out of the plurality of frequency distributions stored in the ROM 42 in association with the onboard load that correspond to the electric current that is closest to the electric current detected chronologically.

Accordingly, even if the electric current flowing to each of the onboard loads L1, L2, . . . Ln is not constant when an arc discharge occurs, it is possible to extract frequency distributions to be compared from among the frequency distributions stored in the storage unit, based on the electric current flowing to the onboard loads L1, L2, . . . Ln when an arc discharge has actually occurred.

Embodiment 3

In contrast to Embodiment 2 in which electric currents flowing to the onboard loads L1, L2, . . . Ln are detected, and frequency distributions to be compared are selected based on the detected electric currents, Embodiment 3 is an embodiment in which frequency distributions to be compared are selected based on electric currents flowing to the onboard loads L1, L2, . . . Ln that are detected when the electric currents decrease by a given ratio or a given amount.

The structure of the onboard load control device 100b and the contents of frequency distributions that are stored in advance in the ROM 42 in Embodiment 3 are the same as those of Embodiment 2, and thus their description is omitted.

When frequency distributions of received intensities detected by the wireless detection unit 46 are later compared with frequency distributions of received intensities stored in the ROM 42, a decrease ratio or decrease amount of the electric current flowing to each of the onboard loads L1, L2, L3, . . . Ln is detected, and it is checked whether or not the detected decrease ratio or decrease amount is larger than a second threshold. Then, the frequency distributions that are detected by the wireless detection unit 46 are compared with the frequency distributions out of a plurality of frequency distributions stored in association with the onboard loads L1, L2, L3, . . . Ln that correspond to the electric current closest to the electric current that was subjected to the above-described checking. If there is a match between the frequency distributions, then the onboard load is identified to which the electric current is flowing via the pair of terminals between which the arc discharge has occurred.

The following will describe an operation of the above-described control unit 40b with reference to the flowchart indicating the operation.

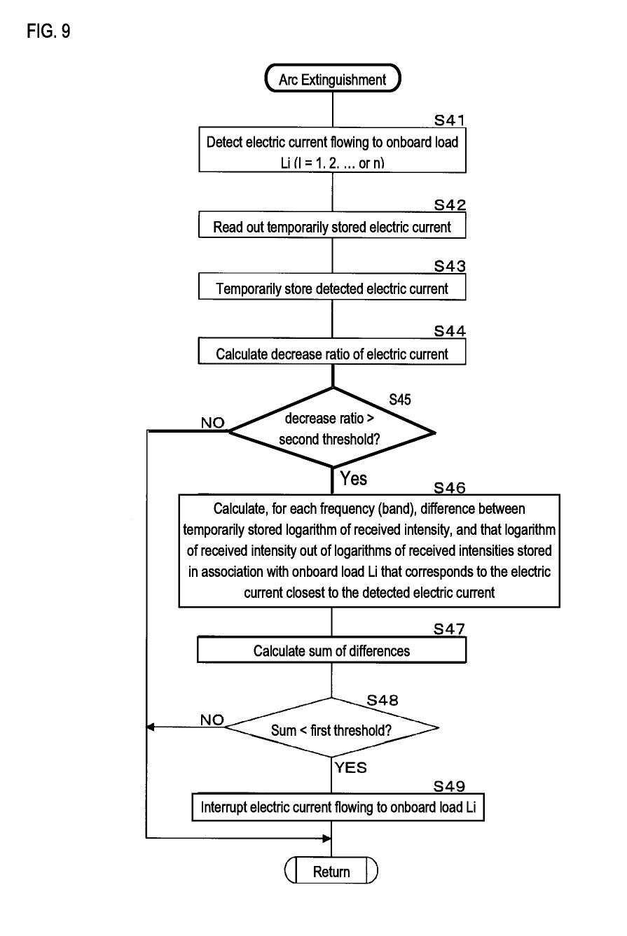

FIG. 9 is a flowchart showing the processing procedure of an arc extinguishing subroutine that is performed by the CPU 41, according to Embodiment 3. The main routine is the same as that of Embodiment 2 shown in FIG. 7, and thus its description is omitted. Furthermore, the processing content in step S41, and steps S46 to S49 shown in FIG. 9 is the same as the processing content in step S31, and steps S36 to 39 shown in FIG. 8 of Embodiment 2, and thus most of its description is omitted.

The arc extinguishing subroutine is invoked, the electric current that is flowing to the onboard load Li (where i is 1, 2, . . . or n) is detected (step S41), and then the CPU 41 reads out the electric current temporarily stored in the RAM 43 when the subroutine was invoked previously (step S42), and temporarily stores the detected electric current (step S43). Accordingly, the electric current to be temporarily stored is replaced by the detected latest electric current.

Then, the CPU 41 calculates a decrease ratio (or a decrease amount) of the electric current based on the detected and temporarily stored electric current, and the read out electric current (step S44), and determines whether or not the calculated decrease ratio (or decrease amount) is greater than the second threshold (step S45: corresponding to a determination unit). If the calculated decrease ratio (or decrease amount) is not smaller than the second threshold (No in step S45), then the CPU 41 returns to the routine from which the subroutine is invoked.

On the other hand, if the calculated decrease ratio (or decrease amount) is greater than the second threshold (Yes in step S45), then the CPU 41 performs comparison of frequency distributions in the same manner as in steps S36 to S39 of FIG. 8 (steps S46 to S48), and if they match (Yes in step S48), then the electric current flowing to the onboard load Li is interrupted (step S49), and the procedure returns to the routine from which the subroutine is invoked.

As described above, according to Embodiment 3, if a decrease ratio or decrease amount of the electric current detected for each of the onboard loads L1, L2, . . . Ln is greater than the second threshold, then the frequency distributions acquired from the wireless detection unit 46 are compared with the frequency distributions out of the plurality of frequency distributions stored in the ROM 42 in association with the onboard loads L1, L2, . . . Ln that correspond to the electric current that is closest to the detected electric current.

Accordingly, since the comparison is performed when an arc discharge has occurred between the terminals 11 and 21, between the terminals 12 and 22, or between the terminals 13 and 23, and an electric resistance has started to increase, it is possible to narrow down the time and target of comparison to reduce the processing load of the comparison.

The embodiments disclosed herein are examples in all respects, and are to be construed as being not limitative. The scope of the present invention is defined in the claims rather than in the meaning of the description above, and all modifications equivalent to and within the scope of the claims are intended to be encompassed. Furthermore, technical features described in the embodiments may be combined with each other.

1. An onboard load control device that turns an electric current on/off that flows via a pair or pairs of terminals of a connector to one or more onboard loads, the onboard load control device comprising:
a wireless detection unit configured to receive an electromagnetic wave and to detect a frequency distribution of received intensities;
a storage unit configured to store in advance, in association with each onboard load, a frequency distribution that is detected by the wireless detection unit when an arc discharge is caused between the pair of terminals through which the electric current flows to the onboard load;
an acquiring unit configured to chronologically acquire a frequency distribution detected by the wireless detection unit;
a comparison unit configured to compare the frequency distribution acquired by the acquiring unit with the frequency distribution stored in the storage unit; and
a current interrupting unit configured to interrupt, if a result of the comparison by the comparison unit shows that the frequency distributions match, the electric current that flows to the onboard load that corresponds to the matching frequency distributions.

2. The onboard load control device according to claim 1,
wherein the comparison unit is configured to perform the comparison of received intensities with respect to each of a plurality of different frequencies or frequency bands.

3. The onboard load control device according to claim 2,
wherein the comparison unit is configured to compare logarithms of the received intensities.

4. The onboard load control device according to claim 3,
wherein the comparison unit is configured to perform the comparison based on a first threshold.

5. The onboard load control device according to claim 1,
wherein the storage unit is configured to store in advance frequency distributions that are detected by the wireless detection unit when an arc discharge is caused with respect to a plurality of electric currents flowing through the pair or pairs of terminals, further in association with the respective electric currents,
a current detecting unit configured to chronologically detect an electric current flowing to the onboard load is provided, and
the comparison unit is configured to compare the frequency distribution acquired by the acquiring unit with that frequency distribution out of the frequency distributions stored in the storage unit in association with the onboard load that corresponds to the electric current that is closest to the electric current detected by the current detecting unit.

6. The onboard load control device according to claim 5, comprising:
a calculation unit configured to calculate a decrease ratio or decrease amount of the electric current detected by the current detecting unit; and
a determination unit configured to determine whether or not the decrease ratio or decrease amount calculated by the calculation unit is greater than a second threshold,
wherein the comparison unit is configured to perform the comparison if it is determined by the determination unit that the decrease ratio or decrease amount is greater than the second threshold.

7. The onboard load control device according to claim 1, further comprising:
a wiring board on which the connector and the wireless detection unit are mounted,
wherein the wiring board is provided with an antenna with which the wireless detection unit receives the electromagnetic wave.

8. A computer program for causing a computer to extinguish an arc discharge occurring in a connector based on a detection result of a wireless detection unit, the computer being connected to: the wireless detection unit configured to receive an electromagnetic wave and to detect a frequency distribution of received intensities; and a storage unit configured to store in advance a frequency distribution that is detected by the wireless detection unit when an arc discharge is caused between a pair of terminals of the connector through which an electric current flows to each of one or more onboard loads in association with the onboard load, and being configured to turn the electric current on/off that flows to the onboard load,
wherein the computer program causes the computer to function as:
an acquiring unit configured to chronologically acquire a frequency distribution detected by the wireless detection unit;
a comparison unit configured to compare the frequency distribution acquired by the acquiring unit with the frequency distribution stored in the storage unit; and
a current interrupting unit configured to perform control to interrupt, if a result of the comparison by the comparison unit shows that the frequency distributions match, the electric current that flows to the onboard load that corresponds to the matching frequency distributions.

9. The onboard load control device according to claim 2, wherein the storage unit is configured to store in advance frequency distributions that are detected by the wireless detection unit when an arc discharge is caused with respect to a plurality of electric currents flowing through the pair or pairs of terminals, further in association with the respective electric currents,
a current detecting unit configured to chronologically detect an electric current flowing to the onboard load is provided, and
the comparison unit is configured to compare the frequency distribution acquired by the acquiring unit with that frequency distribution out of the frequency distributions stored in the storage unit in association with the onboard load that corresponds to the electric current that is closest to the electric current detected by the current detecting unit.

10. The onboard load control device according to claim 3, wherein the storage unit is configured to store in advance frequency distributions that are detected by the wireless detection unit when an arc discharge is caused with respect to a plurality of electric currents flowing through the pair or pairs of terminals, further in association with the respective electric currents,
a current detecting unit configured to chronologically detect an electric current flowing to the onboard load is provided, and
the comparison unit is configured to compare the frequency distribution acquired by the acquiring unit with that frequency distribution out of the frequency distributions stored in the storage unit in association with the onboard load that corresponds to the electric current that is closest to the electric current detected by the current detecting unit.

11. The onboard load control device according to claim 4, wherein the storage unit is configured to store in advance frequency distributions that are detected by the wireless detection unit when an arc discharge is caused with respect to a plurality of electric currents flowing through the pair or pairs of terminals, further in association with the respective electric currents,
a current detecting unit configured to chronologically detect an electric current flowing to the onboard load is provided, and
the comparison unit is configured to compare the frequency distribution acquired by the acquiring unit with that frequency distribution out of the frequency distributions stored in the storage unit in association with the onboard load that corresponds to the electric current that is closest to the electric current detected by the current detecting unit.

12. The onboard load control device according to claim 2, further comprising:
a wiring board on which the connector and the wireless detection unit are mounted,
wherein the wiring board is provided with an antenna with which the wireless detection unit receives the electromagnetic wave.

13. The onboard load control device according to claim 3, further comprising:
a wiring board on which the connector and the wireless detection unit are mounted,
wherein the wiring board is provided with an antenna with which the wireless detection unit receives the electromagnetic wave.

14. The onboard load control device according to claim 3, further comprising:
a wiring board on which the connector and the wireless detection unit are mounted,
wherein the wiring board is provided with an antenna with which the wireless detection unit receives the electromagnetic wave.

15. The onboard load control device according to claim 4, further comprising:
a wiring board on which the connector and the wireless detection unit are mounted,
wherein the wiring board is provided with an antenna with which the wireless detection unit receives the electromagnetic wave.

16. The onboard load control device according to claim 5, further comprising:
a wiring board on which the connector and the wireless detection unit are mounted,
wherein the wiring board is provided with an antenna with which the wireless detection unit receives the electromagnetic wave.

17. The onboard load control device according to claim 6, further comprising:
a wiring board on which the connector and the wireless detection unit are mounted,
wherein the wiring board is provided with an antenna with which the wireless detection unit receives the electromagnetic wave.
